(19) United States
(12) Patent Application Publication
(10) Pub. No.: US 2011/0109075 A1
(43) Pub. Date: May 12, 2011

(54) Sheet music and pamphlet adapter clip

(76) Inventor: Alston Ray Wormwood, Standish, ME (US)

(21) Appl. No.: 12/925,719

(22) Filed: Oct. 28, 2010

Related U.S. Application Data
(60) Provisional application No. 61/280,691, filed on Nov. 9, 2009.

(51) Int. Cl. B42D 17/00

(52) U.S. Cl. 281/46

(57) ABSTRACT

An adapter for holding folded sheet music, cards or the like in ring binders without the need to punch holes or otherwise modify the music. The adapter is in the form of a wire clip that can be pre-attached to, and retained on, the music before the music is mounted in the binder, allowing fast changes of arrangements within the binder.

### CROSS-REFERENCE TO RELATED APPLICATIONS

No. 61/280,691 filed 2009 Nov. 9

### STATEMENT REGARDING FEDERALLY SPONSORED RESEARCH OR DEVELOPMENT

Not Applicable

### BACKGROUND OF THE INVENTION

1. Field of the Invention

This invention relates to the field of ring binders and adapters for same.

2. Background Art

Choral music, such as used by choirs and choruses, consists of sheets folded in the middle. The music could consist of one sheet or multiple sheets folded and assembled at the fold. Those comprising more than one sheet are often stapled along the fold. Such music is frequently held in binders or folders that can hold several selections of music, each of which can be opened, selection by selection and page by page as it is sung. A common three-ring binder is often used for holding the music, and that works well when the music has been punched with three holes. However, some organizations do not permit their music to be punched, especially those selections borrowed from other choral groups or music libraries. In these cases a separate adapter is required to hold the music to the three rings, or a folder other than a three-ring binder is used, leaving the music free to slide out during a concert.

One common adapter used to hold music in a typical three-ring binder is made from a narrow rectangle of thin plastic having three holes along one edge adjacent a long slot through which half the pages of the music may be slid, across to their fold. Either stapled or simply folded music is used with this adapter in the same manner, and the adapter works well for storage or general use, but is somewhat inadequate when the music is being presented in concert. Because this adapter does not clamp the music sheets within the slot it allows unstapled sheets of music to separate and become displaced from the fold. Misaligned folds hinder turning of the pages, a particular problem in music where sections of the score are repeated, requiring abrupt turning of pages backward and forward. Moreover, because the music is free to slide within the adapter slot, even the adapter itself can become misaligned with the fold line at the centerfold.

Similar problems exist with a metal wire adapter as taught by Squire et al. (U.S. Pat. No. 4,645,237), where a free-moving wire retainer is provided for each selection, but where again no provision is made to prevent slipping of sheets out from within the retainer.

There are also purpose-built music holding folders, having means incorporated to serve the same objectives as above. Some of them work well but have shortcomings either because the material they use makes them expensive or has a relatively short service life. Others are not easy to use and do not lend themselves well to changing the order of the music, especially when the change needs to be made in a hurry. Still others are limited by the number of musical selections they can hold. Examples include Clarke (U.S. Pat. No. 71,703) and Girard (U.S. Pat. No. 6,254,135) where a parallel series of elastic strands are employed, each strand to rest within the fold, yet each adjacent strand obstructing the free rotation of sheets that is normally necessary.

### BRIEF SUMMARY OF THE INVENTION

This invention is an improved binder adapter for use in ring binders, one such adapter used for each selection, and each such adapter providing a clamping force against the selection sheets to prevent them from slipping out of place. Each adapter may be preferably formed from a single piece of continuous wire.

### BRIEF DESCRIPTION OF THE SEVERAL VIEWS OF THE DRAWINGS

FIG. 1 is a plan view of the adapter clip, showing its two rings for placement in a ring binder and its two clamping or pinch points for retaining folded sheet music against slippage.

FIG. 2 shows a magnified plan view of a preferred embodiment using flattened wire.

FIG. 3 shows a cross-sectional view of the pinch point in FIG. 2.

FIG. 4 shows a magnified plan view of an alternate embodiment using extra coils in the closed ring.

FIG. 5 shows a cross-sectional view of the pinch point in FIG. 4.

FIG. 6 shows a perspective view of the adapter clip being loaded.

### DETAILED DESCRIPTION OF THE INVENTION

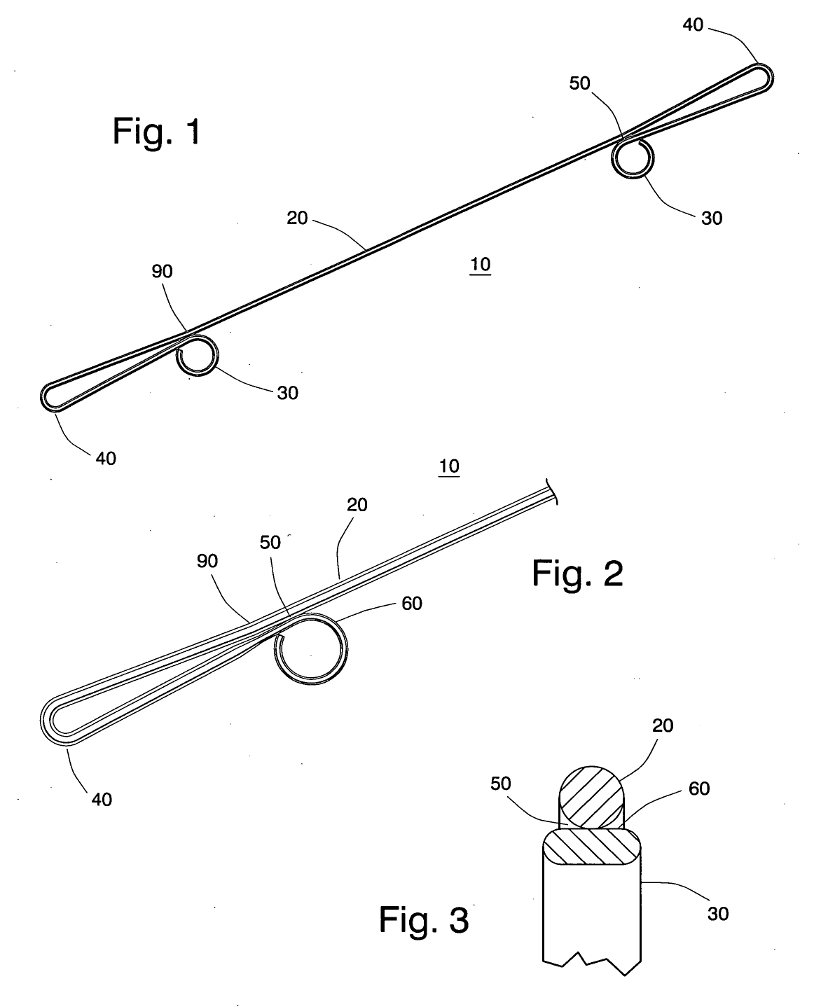

As most simply shown in FIG. 1, the adapter clip 10 comprises a straight length 20 of thin resilient material, such as spring wire, formed with a closed ring 30 at each extreme end and folded back into a loop 40 at a selected distance in from each end, such that a residual clamping force is attained at a pinch point 50 between each end loop 40 and the straight length 20.

The center-to-center distance between the two closed rings 30 is selected to match the distance between end rings in the binder, and the adapter clip's overall length is selected to be greater than the page height of the sheet music or pamphlet envisaged.

In its simplest embodiment, the adapter clip 10 is formed entirely from wire of a circular cross section, and entirely in only two dimensions. In practice, however, simple modifications to this form can substantially improve its functionality.

For example, where two parallel round wires press against one another to form a clamp, there is a tendency for them to slip out of planar alignment and pass by one another. This tendency can be overcome by widening the contact point in some way, such that alignment becomes less critical.

FIG. 2 shows one preferred way to accomplish this by locally flattening the round cross section to afford a flat surface 60, against which the parallel round cross section can bear without such sensitivity to misalignment. Similar results could be attained using wire of square or rectangular cross section. A detail of this type of widening is shown in FIG. 3.

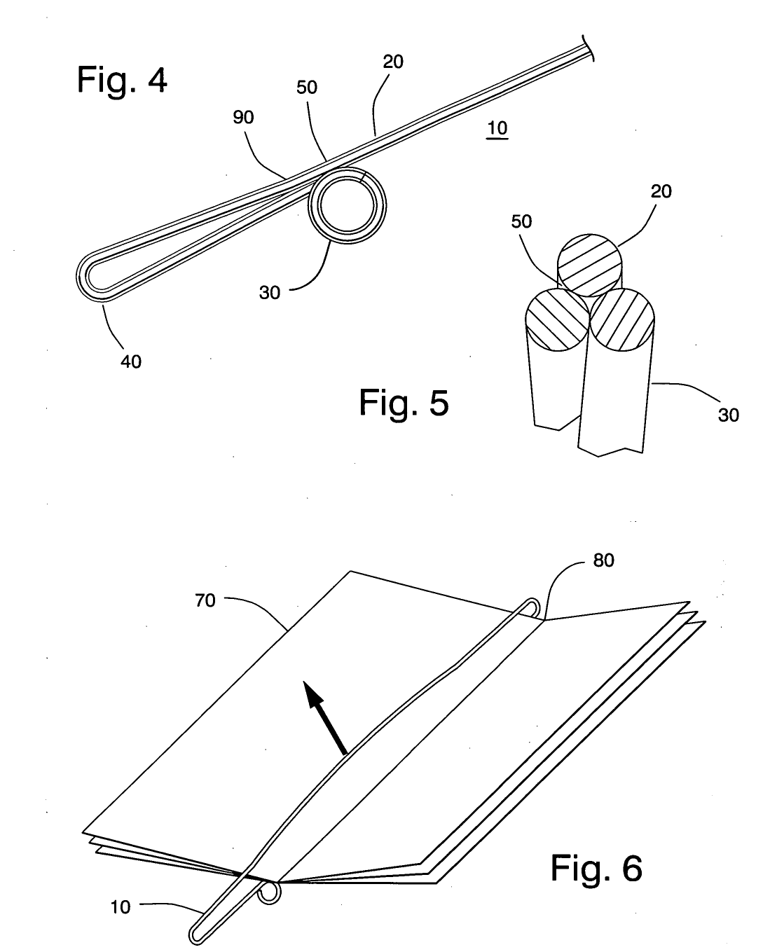

FIG. 4 shows another widened configuration, wherein the end rings 30 are formed of more than one full coil, such that a paired couple of wires is presented to the opposing single-wire section at pinch point 50. In this case, the single wire tends toward remaining in the crevice between the other two. A detail of this manner of widening is shown in FIG. 5.

In practice, material choices and cross-section may be largely influenced by tooling methods and costs. Though envisaged herein as simply made from round steel spring wire, having sufficient plasticity to allow bending into shape yet a high enough yield strength to maintain its shape under normal use, one could as well use wire of square cross-section to obviate flattening, or use heat-treatment to harden the wire after forming, or use an alternative material such as a fiber-reinforced composite.

A preferred embodiment would also include counter-bends 90 in the straight length of the wire, at or immediately beyond each of the pinch points, to afford clearance between the clip and the inserted music where the music extends beyond the pinch point.

Using the adapter clip can be effected in several manners. In one way, a number of empty adapter clips can be pre-loaded into a three-ring binder. To install music on a clip, its folded sheets are first unfolded into their flat configuration. One clip is selected and gripped near the center of its straight length 20. Pulling outward, away from the binder, the straight length 20 bends elastically along its entire length so as to open the two pinch points 50. One edge of the opened music 70 is inserted through the open pinch points 50 and slid across until the fold line coincides with the pinch points. Releasing the straight length 20 relaxes the pinch points 50 so that they clamp the sheets along their fold line 80, after which the music can be re-folded around the clip 10 where it will retained until released, even if removed from the binder.

Another manner of use is to pre-load the adapter clip onto the music before inserting it into the binder. This method allows very quick re-arrangement of the music selections within the binder. Pre-loading is accomplished by sliding one the two pinch points 50 over an end of the fold line 80 of the music with the straight length along the inside of the fold, then flattening the music into its fully open position and buckling it across the fold line to permit sliding the free end of fold line 80 into the other pinch point 50. Closing the folded music presents a configuration that may be freely inserted or removed as a unit from the binder.

As can be seen from the above, this adapter clip can be used in many sizes of binders and with many sizes of paper, folded cards or pamphlet, and even used as a hanger for such articles. For various uses, it can be made from a variety of resilient materials and with a variety of cross-sections.

I claim:

1. An adapter clip for use in a ring binder or the like, adapted to hold and retain folded sheet music in said binder without modification to said music, comprising:
a. a straight predetermined length of wire, formed by bending at predetermined locations to create two symmetrical coplanar opposing ends connected by a straight length, each said end comprising
(1) a closed ring of a predetermined diameter formed at and tangent to said end of said straight length; and
(2) a rounded bend of greater than 180 degrees having a predetermined radius, located a predetermined distance inward along said straight length from said closed ring, and formed such that said closed ring is in residual compressive contact with said straight length of said wire to form a pinch point therebetween.

2. The adapter clip of claim 1 wherein said closed ring is a single closed coil formed entirely in two dimensions.

3. The adapter clip of claim 2 wherein a portion of said round wire is flattened at said pinch point to create a single point of contact between said closed ring and said straight length and within said flattened portion.

4. The adapter clip of claim 1 wherein said closed ring is formed as a closed helix of greater than one coil to create thereby an adjacent pair of round wire coils bearing against said straight length of round wire, and thus a pair of point contacts therebetween.

5. The adapter clip of claim 1 wherein a counter-bend is formed in said straight length at a position proximate to each said pinch point, such that an imaginary extension line along said straight length would bisect the angle formed by each leg of said rounded bend of greater than 180 degrees.

6. The adapter clip of claim 1 wherein said wire is of square cross-section, forming thereby a line contact between said straight length and each of said closed rings.

7. A method for holding folded sheet paper of single or multiple sheets in a ring binder, comprising the steps of:
a. opening the snap rings of said ring binder;
b. inserting within two of said open snap rings the two said closed rings of said adapter clip of claim 1;
c. closing said snap rings to retain therein the two closed rings of said adapter clip, and thereby retaining said adapter clip in said ring binder;
d. lifting away from said binder said straight length portion of said adapter clip such that said residual compressive contact at said two pinch points is overcome and said pinch points are thereby held open for insertion of said paper sheets;
e. opening said paper sheets at said fold into a flat form;
f. aligning said fold parallel to said straight length and sliding an edge of said paper sheets under said straight length and over said two closed rings of said adapter clip until said fold aligns directly beneath said straight length and directly above said two pinch points;
g. releasing said straight length to allow said residual compressive contact to be restored, thereby both holding and retaining said sheets along said fold; and
h. folding said sheets together into their original folded form,
thereby allowing said adapter clip to hold and retain said folded sheets as a unit, yet allowing said folded unit to slip freely around said binder snap rings without need for holes or other modifications being made to said folded sheets; and
affording free turning of pages among said sheets, backwardly and forwardly, without causing misalignment and obstruction of said turning; and
allowing said adapter clip together with said sheets to be removed as a unit from, moved into new location and again retained within said snap rings for serial rearrangement of a series of such units; and
allowing removal of said sheets as a unit from between said pinch points by reversal of the above process, affording no harm to said sheets at any time.
